(19) United States
(12) Patent Application Publication
(10) Pub. No.: US 2014/0225618 A1
(43) Pub. Date: Aug. 14, 2014

(54) REMOTE CONTROL SWITCHING DEVICE TO CONTROL SEPARATE DETECTION OF A PLURALITY OF BURIED CONDUCTORS

(71) Applicant: RADIODETECTION LTD., BRISTOL (GB)

(72) Inventor: Michael Drew GREER, Prospect, OH (US)

(21) Appl. No.: 14/159,026

(22) Filed: Jan. 20, 2014

Related U.S. Application Data
(63) Continuation-in-part of application No. 13/762,501, filed on Feb. 8, 2013.

(51) Int. Cl. G01V 3/08

(52) U.S. Cl. CPC G01V 3/08
USPC 324/326

(57) ABSTRACT

A system for detecting a plurality of buried conductors includes a transmitter configured to generate an alternating test signal for a plurality of buried conductors. The system further includes a receiver configured to detect an electromagnetic field produced by the alternating test signal in the plurality of buried conductors and a remote control configured to control the transmitter to generate the alternating test signal in one of the plurality of buried conductors.

### CROSS-REFERENCE TO RELATED APPLICATIONS

This application is a continuation in part of U.S. application Ser. No. 13/762,501 filed on Feb. 8, 2013, which is hereby incorporated by reference in its entirety for all purposes as if fully set forth herein.

### FIELD OF THE INVENTION

The invention relates to a system for and method of separately detecting a plurality of buried conductors. More specifically, the invention relates to a system for and method of remotely controlling separate detection of a plurality of buried conductors.

### BACKGROUND OF THE INVENTION

Before commencing excavation or other work where electrical cables, fiber optic cables, ducts, pipes, or other utilities are buried, it is important to determine the location of such buried utilities to ensure that the buried utilities are not damaged during the work.

Utilities, such as fiber optic cables, non-metallic utilities ducts, pipes or the like are typically fitted with a small electrical tracer line in which an alternating electrical current can be induced in the tracer line which in turn radiates electromagnetic radiation. Other utilities may allow an alternating electrical current to be induced in other ways which in turn radiates electromagnetic radiation.

One type of such detector works in one of two modes, namely ‘active’ or ‘passive’ modes. Each mode has its own frequency bands of detection.

The passive mode comprises ‘power mode’ and ‘radio’ mode. In power mode, the detector detects the magnetic field produced by a conductor carrying an AC mains power supply at 50/60 Hz, or the magnetic field re-radiated from a conductor as a result of a nearby cable carrying AC power, together with higher harmonics up to about 5 KHz. In radio mode, the detector detects very low frequency (VLF) radio energy which is re-radiated by buried conductors.

In the active mode, a signal transmitter produces an alternating magnetic field of known frequency and modulation, which induces a current in a nearby buried conductor. The signal transmitter may alternatively be directly connected to the conductor or, where direct connection access is not possible, a signal transmitter may be placed near the buried conductor and a signal may be induced in the conductor. The buried conductor re-radiates the signal produced by the signal transmitter.

When the operator is seeking to determine the location of a plurality of utilities using the active mode with direct connection, the operator must connect the signal transmitter to a first utility and then locate the first utility. Then the operator must subsequently connect the signal transmitter to a second utility and then locate the second utility. The process is repeated for each subsequent utility. This requires an operator to make several trips between the signal transmitter location and the location where the utility is being located. This multiple trip process can be time consuming and inefficient.

Accordingly, an improved system for detecting a plurality of buried conductors which overcomes some of the disadvantages of conventional systems is needed.

### SUMMARY OF THE INVENTION

The foregoing needs are met, to a great extent, by the invention, wherein in one aspect a technique and apparatus are provided to more quickly and efficiently locate a plurality of utilities.

In accordance with one embodiment, a system for detecting a plurality of buried conductors includes a transmitter configured to generate an alternating test signal for a plurality of buried conductors, a receiver configured to detect an electromagnetic field produced by the alternating test signal in the plurality of buried conductors, and a remote control configured to control the transmitter to generate the alternating test signal in one of the plurality of buried conductors.

In an embodiment, the transmitter is configured to connect to each of the plurality of buried conductors.

In an embodiment, the transmitter is configured to connect to each of the plurality of buried conductors through a switch, wherein the switch is configured to transmit the alternating test signal to one of the plurality of buried conductors.

In an embodiment, the transmitter is configured to connect to each of the plurality of buried conductors through a switch, wherein the switch is configured to transmit the alternating test signal to one of the plurality of buried conductors; and wherein the remote control is configured to operate the switch to select which one of the plurality of buried conductors receives the alternating test signal.

In an embodiment, the transmitter is configured to connect to each of the plurality of buried conductors through a switch, wherein the switch is configured to transmit the alternating test signal to one of the plurality of buried conductors; and wherein the remote control is configured to wirelessly operate the switch to select which one of the plurality of buried conductors receives the alternating test signal.

In an embodiment, the system further comprises: analog to digital converters to convert field strength signals into digital signals; and a digital signal processor arranged to process the digital signals and to isolate signals of predetermined frequency bands, wherein the receiver includes a plurality of antennas for detecting the electromagnetic field produced by the alternating test signal in the plurality of buried conductors, and each of the plurality of antennas outputs a field strength signal representative of the electromagnetic field at each of the plurality of antennas.

In an embodiment, the system further comprises: a plurality of couplers each configured to couple the alternating test signal with one of the plurality of buried conductors.

In an embodiment, the transmitter is configured to connect to each of the plurality of couplers through a switch, wherein the switch is configured to connect the alternating test signal to one of the plurality of couplers.

In an embodiment, the plurality of couplers comprise an inductive coupler configured to inductively couple the alternating test signal with a first buried conductor of the plurality of buried conductors and a direct coupler configured to directly couple the alternating test signal with a second buried conductor of the plurality of buried conductors.

In an embodiment, the transmitter is configured to output the alternating test signal between an alternating output and a ground return path, the switch is coupled to a connection configured to be coupled to a ground stake inserted in the ground in which the plurality of buried conductors are buried and the switch is configured to couple the ground return path of the transmitter to the ground stake when the alternating test signal is connected to the direct coupler.

In an embodiment, the transmitter comprises a test signal selector configured to select the alternating test signal according to a coupler type detected from a coupler connected to the transmitter, and wherein a first coupler of the plurality of couplers comprises a coupler type indicator indicating the coupler type of the first coupler, and the switch is configured to connect the coupler type indicator of the first coupler to the transmitter when the first coupler is connected to the transmitter.

In an embodiment, the remote control is configured to operate the switch to select which one of the plurality of buried conductors receives the alternating test signal.

In an embodiment, the remote control is configured to communicate with the switch over wireless connection comprising a plurality of channels and the remote control and the switch are configured to perform a pairing procedure to select one channel from the plurality of channels.

In accordance with another embodiment, a system for detecting a plurality of buried conductors includes means for producing an alternating test signal in a plurality of buried conductors, means for detecting an electromagnetic field produced by the alternating test signal in the plurality of buried conductors, and means for remotely controlling the means for producing to generate the alternating test signal in one of the plurality of buried conductors.

In an embodiment, the means for producing is configured to connect to each of the plurality of buried conductors.

In an embodiment, the means for producing is configured to connect to each of the plurality of buried conductors through a switch, wherein the switch is configured to transmit the alternating test signal to one of the plurality of buried conductors.

In an embodiment, the means for producing is configured to connect to each of the plurality of buried conductors through a switch, wherein the switch is configured to transmit the alternating test signal to one of the plurality of buried conductors; and wherein the means for remotely controlling is configured to operate the switch to select which one of the plurality of buried conductors receives the alternating test signal.

In an embodiment, the means for producing is configured to connect to each of the plurality of buried conductors through a switch, wherein the switch is configured to transmit the alternating test signal to one of the plurality of buried conductors; and wherein the means for remotely controlling is configured to wirelessly operate the switch to select which one of the plurality of buried conductors receives the alternating test signal.

In an embodiment, the system further comprises: analog to digital converters to convert field strength signals into digital signals; and a digital signal processor arranged to process the digital signals and to isolate signals of predetermined frequency bands, and the receiver includes a plurality of antennas for detecting the electromagnetic field produced by the alternating test signal in the plurality of buried conductors, and each of the plurality of antennas output a field strength signal representative of the electromagnetic field at each of the plurality of antennas.

In an embodiment, the system further comprises a plurality of couplers each configured to couple the alternating test signal with one of the plurality of buried conductors.

In an embodiment, the means for producing an alternating test signal is configured to connect to each of the plurality of couplers through a switch, wherein the switch is configured to connect the alternating test signal to one of the plurality of couplers.

In an embodiment, the plurality of couplers comprise an inductive coupler configured to inductively couple the alternating test signal with a first buried conductor of the plurality of buried conductors and a direct coupler configured to directly couple the alternating test signal with a second buried conductor of the plurality of buried conductors.

In an embodiment, the means for producing an alternating test signal is configured to output the alternating test signal between an alternating output and a ground return path, the switch is coupled to a connection configured to be coupled to a ground stake inserted in the ground in which the plurality of buried conductors are buried and the switch is configured to couple the ground return path of the means for producing an alternating test signal to the ground stake when the alternating test signal is connected to the direct coupler.

In an embodiment, the means for producing an alternating test signal comprises means for selecting the alternating test signal according to a coupler type detected from a coupler connected to the means for producing an alternating test signal, and wherein a first coupler of the plurality of couplers comprises a coupler type indicator indicating the coupler type of the first coupler, and the switch is configured to connect the coupler type indicator of the first coupler to the transmitter when the first coupler is connected to the means for producing an alternating test signal.

In an embodiment, the means for remotely controlling is configured to operate the switch to select which one of the plurality of buried conductors receives the alternating test signal.

In an embodiment, the means for remotely controlling is configured to communicate with the switch over wireless connection comprising a plurality of channels and the means for remotely controlling and the switch are configured to perform a pairing procedure to select one channel from the plurality of channels.

In accordance with a further embodiment, a method of detecting a plurality of buried conductors includes providing a transmitter for producing an alternating test signal in a plurality of buried conductors, providing a receiver for detecting an electromagnetic field produced by the alternating test signal in the plurality of buried conductors, and controlling the transmitter with a remote control to generate the alternating test signal in one of the plurality of buried conductors.

In an embodiment, the providing a transmitter includes connecting the transmitter to each of the plurality of buried conductors.

In an embodiment, the providing a transmitter includes connecting the transmitter to each of the plurality of buried conductors through a switch, wherein the switch is configured to transmit the alternating test signal to one of the plurality of buried conductors.

In an embodiment, the providing a transmitter includes connecting the transmitter to each of the plurality of buried conductors through a switch, wherein the switch is configured to transmit the alternating test signal to one of the plurality of buried conductors; and wherein the remote control includes the switch to select which one of the plurality of buried conductors receives the alternating test signal.

In an embodiment, the providing a transmitter includes connecting the transmitter to each of the plurality of buried conductors through a switch, wherein the switch is configured to transmit the alternating test signal to one of the plurality of buried conductors; and wherein the remote control includes wireless communication to select which one of the plurality of buried conductors receives the alternating test signal.

In an embodiment, the receiver comprises analog to digital converters to convert field strength signals into digital signals and a digital signal processor arranged to process the digital signals and to isolate signals of predetermined frequency bands; wherein the receiver includes a plurality of antennas for detecting the electromagnetic field produced by the alternating test signal in the plurality of buried conductors, and wherein each of the plurality of antennas output a field strength signal representative of the electromagnetic field at each of the plurality of antennas.

In an embodiment, the receiver comprises a plurality of antennas for detecting the electromagnetic field produced by the alternating test signal in the plurality of buried conductors.

In an embodiment the method further comprises associating the remote control with at least one of the transmitter and the switch to one of prevent and reduce erroneous operation.

In an embodiment, the remote control is configured to communicate with the switch over wireless connection comprising a plurality of channels and associating the remote control with at least one of the transmitter and the switch.

In an embodiment, the method further comprises providing a plurality of couplers each configured to couple the alternating test signal with one of the plurality of buried conductors.

In an embodiment, the method further comprises providing a switch, wherein the transmitter is configured to connect to each of the plurality of couplers through the switch, and wherein the switch is configured to connect the alternating test signal to one of the plurality of couplers.

In an embodiment, the plurality of couplers comprise an inductive coupler configured to inductively couple the alternating test signal with a first buried conductor of the plurality of buried conductors and a direct coupler configured to directly couple the alternating test signal with a second buried conductor of the plurality of buried conductors.

In an embodiment, the transmitter is configured to output the alternating test signal between an alternating output and a ground return path, the switch is coupled to a connection configured to be coupled to a ground stake inserted in the ground in which the plurality of buried conductors are buried and the switch is configured to couple the ground return path of the transmitter to the ground stake when the alternating test signal is connected to the direct coupler.

In an embodiment, the transmitter comprises a test signal selector configured to select the alternating test signal according to a coupler type detected from a coupler connected to the transmitter, and wherein a first coupler of the plurality of couplers comprises a coupler type indicator indicating the coupler type of the first coupler, and the switch is configured to connect the coupler type indicator of the first coupler to the transmitter when the first coupler is connected to the transmitter.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

The present invention will now be described in further detail, purely by way of example, with reference to the following drawings:

FIG. 1 shows a schematic representation of a system for detecting buried conductors according to an aspect of the invention.

FIG. 2 is a block diagram of an exemplary transmitter of the system of FIG. 1 according to an aspect of the invention.

FIG. 3 is a block diagram of an exemplary receiver of the system of FIG. 1 according to an aspect of the invention.

FIG. 4 is a block diagram of the transmitter and switch of the system of FIG. 1 according to an aspect of the invention.

FIG. 5 is a block diagram of the remote control of the system of FIG. 1 according to an aspect of the invention.

FIG. 6 is a detailed block diagram of the switch of the system of FIG. 1 according to an aspect of the invention.

FIG. 7 is a detailed diagram of an external configuration of the remote control of the system of FIG. 1 according to an aspect of the invention.

FIG. 8 is a block diagram of a switch according to an embodiment of the invention.

### DETAILED DESCRIPTION

The invention will now be described with reference to the drawing figures, in which like reference numerals refer to like parts throughout. Embodiments of the invention advantageously provide a device and method for more quickly and efficiently detect a plurality of utilities.

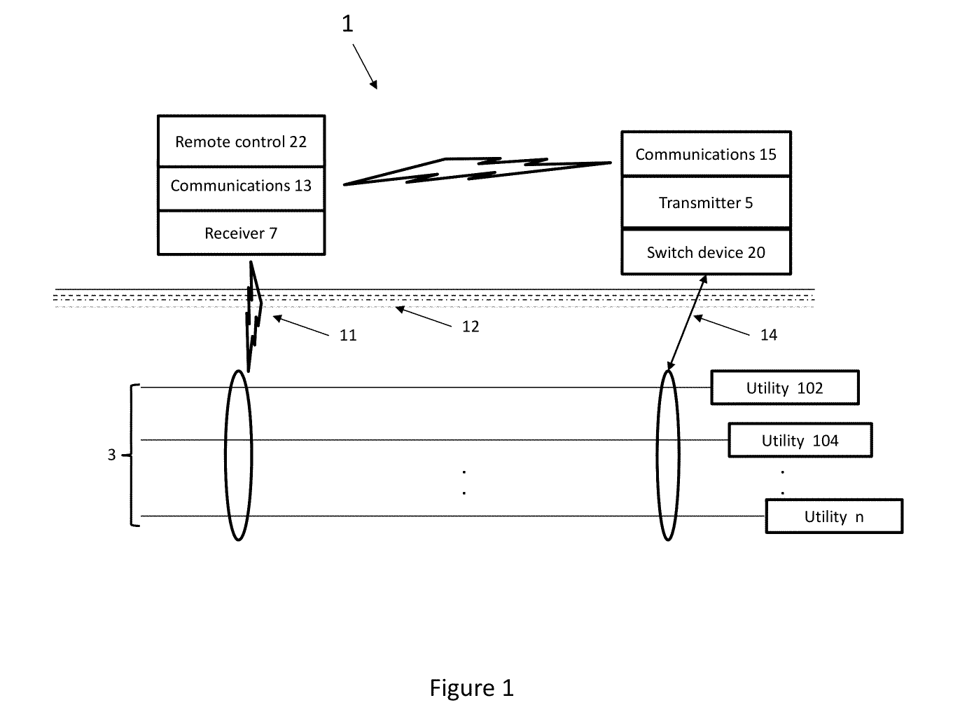

FIG. 1 shows a schematic representation of a system for detecting buried conductors according to an aspect of the invention. In particular, FIG. 1 is a schematic representation of a system 1 for detecting a plurality of buried conductors 3 according to an aspect of the invention, including a portable transmitter 5 and a portable receiver 7. The transmitter 5 may be placed in proximity to the plurality of buried conductors 3 and electrically connected to the plurality of buried conductors 3. The buried conductors 3 may in some cases be buried, at least partially, underground 12.

The transmitter 5 may generate an alternating current test signal and fed the alternating current test signal to one of the buried conductors 3 through a connection 14. In particular, the transmitter 5 may be connected to a plurality of the buried conductors 3 such as Utility One, Utility Two, . . . Utility n (wherein n is an integer). A single one of the buried conductors may be selectively connected to the transmitter 5 and the selective connection may be achieved with a switch device 20 as described in detail below.

The receiver 7 receives and detects the electromagnetic field 11 produced by the test current in the one of the buried conductors 3 that is fed the alternating current test signal. The receiver 7 may further include a remote control 22 to operate the switch device 20 to selectively connect the transmitter 5 to another one of the plurality of buried conductors 3. The remote control 22 may be configured as a separate component from the receiver 7. In this regard, the remote control 22 may be utilized to operate with existing receivers 7. Alternatively, the remote control 22 may be incorporated and/or integrated into the receiver 7 to provide the operator with a single unified device.

More specifically, operation of the remote control 22 can function to operate the switch device 20 to connect one of the plurality of buried conductors 3 to the transmitter 5. Accordingly, the operator can set up the transmitter 5 to be connected to each of the plurality of buried conductors 3. The operator can then operate the receiver 7 and remote control 22 such that only one of the plurality of buried conductors 3 may receive an alternating current test signal, the operator can then detect the electromagnetic field 11 emitted from the one of the plurality of buried conductors 3 receiving the alternating current test signal. Thereafter, the operator can use the remote control 22 to control the switch device 20 such that another one of the buried utilities receives the alternating current test signal. Subsequently, the operator can use the receiver 7 to detect the electromagnetic field 11 emitted from that subsequent one of the plurality of buried conductors 3. This process can be repeated for other ones of the plurality of buried conductors 3. Accordingly, the operator does not have to physically travel back to the transmitter 5 and disconnect the transmitter 5 from one of the plurality of buried conductors 3 and connect the transmitter 5 to another one of the plurality of buried conductors 3. The connecting and disconnecting may be performed by the switch device 20 as controlled by the operator is using the remote control 22 from a remote distance.

In an alternative aspect, the transmitter 5 may include a plurality of aerials. The transmitter 5 may feed an AC voltage test signal to one of the plurality of aerials to produce a magnetic field which links around one of the buried conductors 3, thereby inducing an alternating current test signal in the buried conductor 3 adjacent one of the plurality of aerials. The alternating current test signal is radiated as an electromagnetic field 11 by the buried conductor 3 which can be detected by the receiver 7. Again, the switch device 20 may control which aerial produces a magnetic field and which one of the buried conductors 3 produces the electromagnetic field 11. Which one of the plurality of aerials transmits the AC voltage test signal may be controlled by the switch device 20 as controlled by the operator using the remote control 22 from a remote distance.

Both the transmitter 5 and receiver 7 may include a communications module 13, 15. Each communications module 13, 15 may include a transceiver that provides a communication link between the receiver 7 and the transmitter 5. Control signals may be transmitted using a wireless communications technique using the Bluetooth™ standard, wireless fidelity (Wi-Fi) standard, ZigBee™ standard, or the like. In other aspects, other wired or wireless techniques may be used to transmit control signals between the receiver 7 and the transmitter 5.

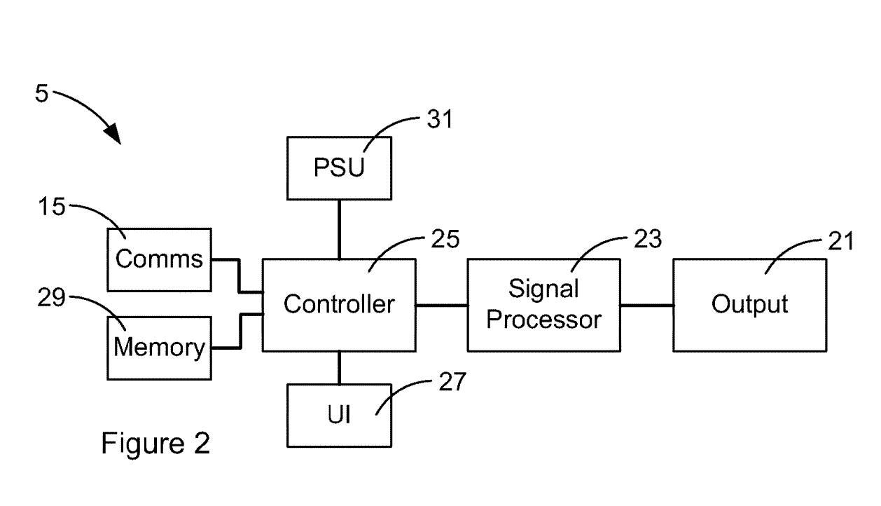

FIG. 2 is a block diagram of an exemplary transmitter of the system of FIG. 1 according to an aspect of the invention. In particular, FIG. 2 is a block diagram of the portable transmitter 5 of the system 1 of FIG. 1. The alternating current test signal may be output by an output module 21 and coupled to the buried conductors 3 to produce the alternating test current in the buried conductor 3. In particular aspects where direct access to the conductor is available, the transmitter 5 signal may be applied to the buried conductor 3 by directly connecting the output module 21 to each of the buried conductors 3 or by clamping the output module 21 around the buried conductor 3. For example, the output module 21 may include croc clips, banana connectors, hardwired connections, or the like to connect to the switch device 20.

The test signal produced by the output module 21 may be controlled by a signal processor module 23. The signal processor module 23 may set a power, frequency and modulation scheme of the signal to be applied to the buried conductor 3. The signal processor module 23 and output module 21 may be controlled by a controller 25. The operation of the transmitter 5 may be set either by an operator via a user interface module 27 or by the commands received at the communications module 15 sent from the receiver 7.

The user interface module 27 may convey information to the operator of the transmitter 5 and may include one or more of a display for displaying information to the operator of the device, input devices such as a keypad or a touch sensitive screen and audible output devices such as a speaker or beeper. In addition to the communications module 15 sending and receiving commands to/from the communications module 13 of the receiver 7, the communications module 15 may also enable the transmitter 5 to be connected to a personal computer (PC) or a personal digital assistant (PDA) (not shown). The transmitter 5 further may include a memory module 29 and a power supply unit (PSU) 31 that includes a power source such as batteries, power management circuitry, or the like.

The transmitter 5 may include a device for calculating the complex impedance of the ground 12 at the transmitter 5. The complex impedance of the ground 12 may be measured by comparing a phase and magnitude of the voltage driving the output module 21 with the phase and magnitude of the current through the output module 21. The relationship between these phases depends on the nature of the load (the utility) to which the test signal is applied. If the load is dominantly resistive then the current and voltage may be substantially in phase. For a dominantly capacitive load, the current may lead the voltage at a phase angle up to 90 degrees and if the load is dominantly inductive then the current may lag the voltage by a phase angle up to 90 degrees. The transmitter 5 may further include additional components to address other signal related issues. The components of the portable transmitter 5 may be housed in a housing (not shown).

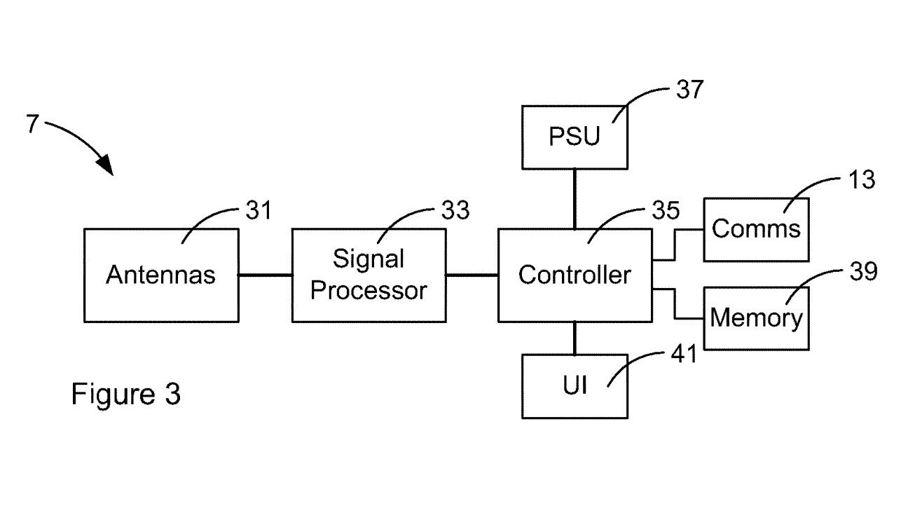

FIG. 3 is a block diagram of an exemplary receiver of the system of FIG. 1 according to an aspect of the invention. In particular, FIG. 3 is a block diagram of the portable receiver 7 of the system 1 of FIG. 1. An electromagnetic field 11 radiated by the buried conductor 3 may be detected by antennas in an antenna module 31. Each antenna outputs a field strength signal representative of the electromagnetic field at the antenna. The outputs from the antenna module 31 may be fed into a signal processor module 33 for isolating signals of a desired frequency or frequencies and processes these signals to derive their characteristics. The signal processor module 33 may include a pre-amplification stage for amplifying the field strength signals output from the antennas if the detected signal is weak. The signal processor module 33 further may include an analogue to digital converter for converting the field strength signals into digital signals and a digital signal processor block for processing the digitized signals. Like the transmitter 5, the receiver 7 also may include a controller 35, PSU 37, communications module 13, memory 39 and user interface 41. The components of the portable receiver 7 may be housed in a housing (not shown).

The communications modules 13, 15 of the receiver 7 and the transmitter 5 provide a communication/data link between the receiver 7 and the transmitter 5 which enhances the locating experience of the operator of the system 1, simplifies the operator interface and facilitates single user operation of the transmitter 5 and the receiver 7. In one aspect, the communication link may be a radio frequency telemetry system providing half-duplex communication between the transmitter 5 and the receiver 7. In other aspects a full duplex communication link may be used.

By using a long range Bluetooth transceiver, such as the Ezurio Bluetooth® Serial Module BISM II available from Laird Technologies, Earth City, Mo. USA, the communication link between the transmitter 5 and the receiver 7 may be maintained up to a line of sight range of, for example, 800 m. This communication standard may provide a good balance between the range of the communication link and low power consumption required from the batteries of the transmitter 5 and receiver 7 to maintain the communication link. Alternative communication standards may be used in other embodiments.

In one aspect the receiver 7 may take full-authority control of the transmitter 5. The communication transport layer may be based on a standard slip protocol suitable for asynchronous and synchronous serial data. The receiver 7 may act as the bus master and the transmitter 5 as a slave. All commands sent from the receiver 7 to the transmitter 5 may be acknowledged by the transmitter 5 to allow the transmitter 5 and the receiver 7 to be synchronized. In the event of a checksum error or an acknowledge signal not being received by the receiver 7, both the receiver 7 and the transmitter 5 may assume the command to be inactive.

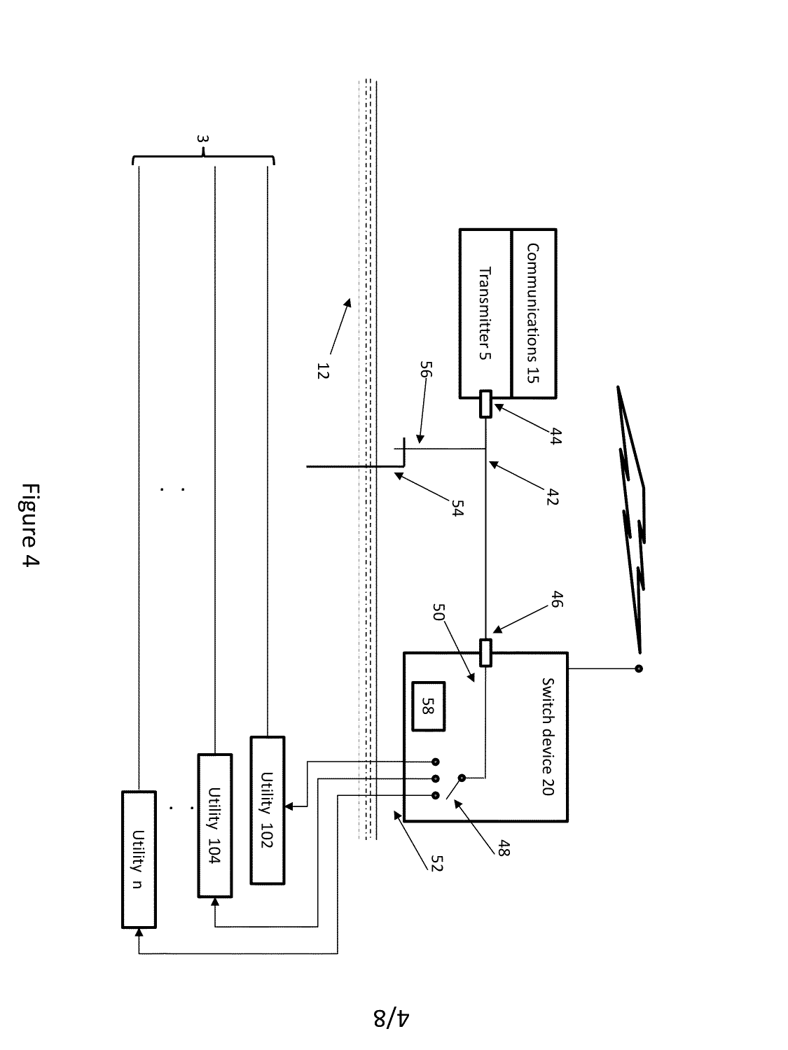

FIG. 4 is a block diagram of the transmitter and switch device of the system of FIG. 1 according to an aspect of the invention. In particular, the transmitter 5 may electrically connect to the switch device 20 via line 42. In this aspect, the transmitter 5 and the switch device 20 are two separate components. The line 42 may include a connector 44 that connects the line 42 to the transmitter 5. The connector 44 may be a croc clip, banana plug, hardwired connections, or the like. Additionally the line 42 may include a connector 46 that connects the line 42 to the switch device 20. The connector 46 may be a croc clip, banana plug, hardwired connections, or the like. This arrangement allows the alternating current test signal output from transmitter 5 to be input to the switch device 20. Additionally, the line 42 may be implemented as a wireless connection using a wireless communication channel.

Alternatively, the transmitter 5 may incorporate the switch device 20 into the housing of the transmitter 5. Accordingly, the line 42 may be a hardwired connection to the transmitter 5 or may be incorporated into the circuitry of the transmitter 5 or the output module 21.

The switch device 20 may include an input 50 that receives the alternating current test signal from the transmitter 5. The input 50 may connect to a switch 48 that selectively connects the signal received by the input 50 to one of a plurality of outputs 52. The switch 48 may be configured as a demultiplexer or similar switching arrangement. Depending on the position of the switch 48, the alternating current test signal may be transferred from the input 50 to a specific one of the outputs 52.

Operation of the switch 48 may be controlled by the remote control 22 to move the switch 48 to one of a plurality of positions. Each position connects the input 50 to one of the outputs 52. The switch position of the switch 48 may further be controlled by an input 58 configured with the switch device 20.

The transmitter 5 and the switch device 20 may further include the need to send a signal to ground, obtain a signal from ground, and/or be grounded. In one aspect, the transmitter 5 may connect a line 56 to ground that may include a stake 54. The line 56 may be separate from line 42 or combined with line 42.

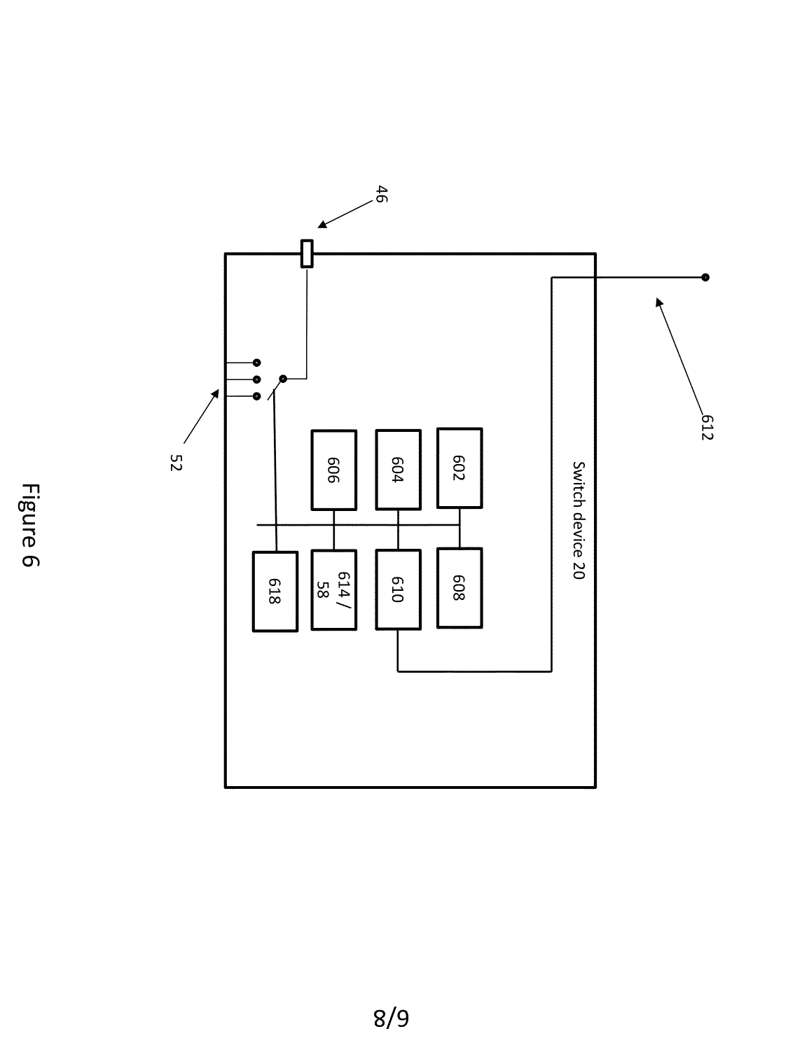

FIG. 6 is a detailed diagram of the switch of the system of FIG. 1 according to an aspect of the invention. The switch device 20 may include a microprocessor 602, a read-only memory 604, a random access memory 606, a battery or other power source 608, a transceiver 610, an antenna 612 connected to the transceiver 610, a display 618, and a user interface 614. The user interface 614 may include the input 58. Other configurations providing similar or additional functionality are contemplated as well. The transceiver 610 may operate using a wireless communications technique using the Bluetooth™ standard, wireless fidelity (Wi-Fi) standard, ZigBee™ standard, or the like. The display 618 may display the functionality of the switch device 20 including a power status, a connection status, a current switch configuration, potential errors, and the like. The user interface 614 may allow the user to operate the switch device 20 including controlling various functionalities of the switch device 20 including power, switch 48 position, and the like.

The respective outputs 52 may then be transferred from the outputs 52 to one of the buried conductors 3 such as Utility One, Utility Two, . . . Utility n (wherein in is an integer). The transfer from the output may be achieved with a connector, a line, and another connector. The connectors may include croc clips, banana connectors, hardwired connections, or the like to connect to each of the buried conductors 3. Other arrangements are contemplated as well.

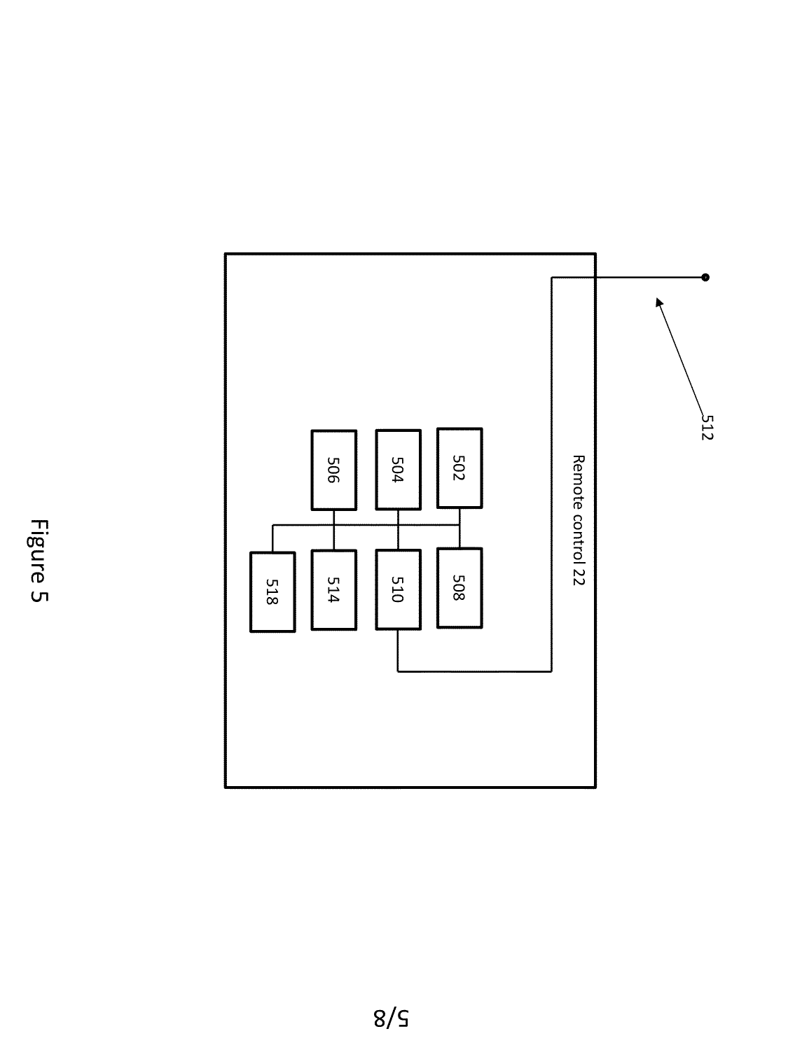

FIG. 5 is a block diagram of the remote control of the system of FIG. 1 according to an aspect of the invention. The remote control 22 may include a microprocessor 502, a read-only memory 504, a random access memory 506, a battery or other power source 508, a transceiver 510, and an antenna 512 connected to the transceiver 510, a display 514, and a user interface 518. Other configurations providing similar functionality are contemplated as well. The transceiver 510 of the remote control 22 may operate using a wireless communications technique using the Bluetooth™, wireless fidelity (Wi-Fi), ZigBee™, standard or the like. The display 514 may display the functionality of the remote control 22 including a power status, a connection status, a current switch configuration, potential errors, and the like. The user interface 518 may allow the user to operate the remote control 22 including controlling various functionalities of the remote control 22 including power, switch 48 position of the switch device 20, and the like.

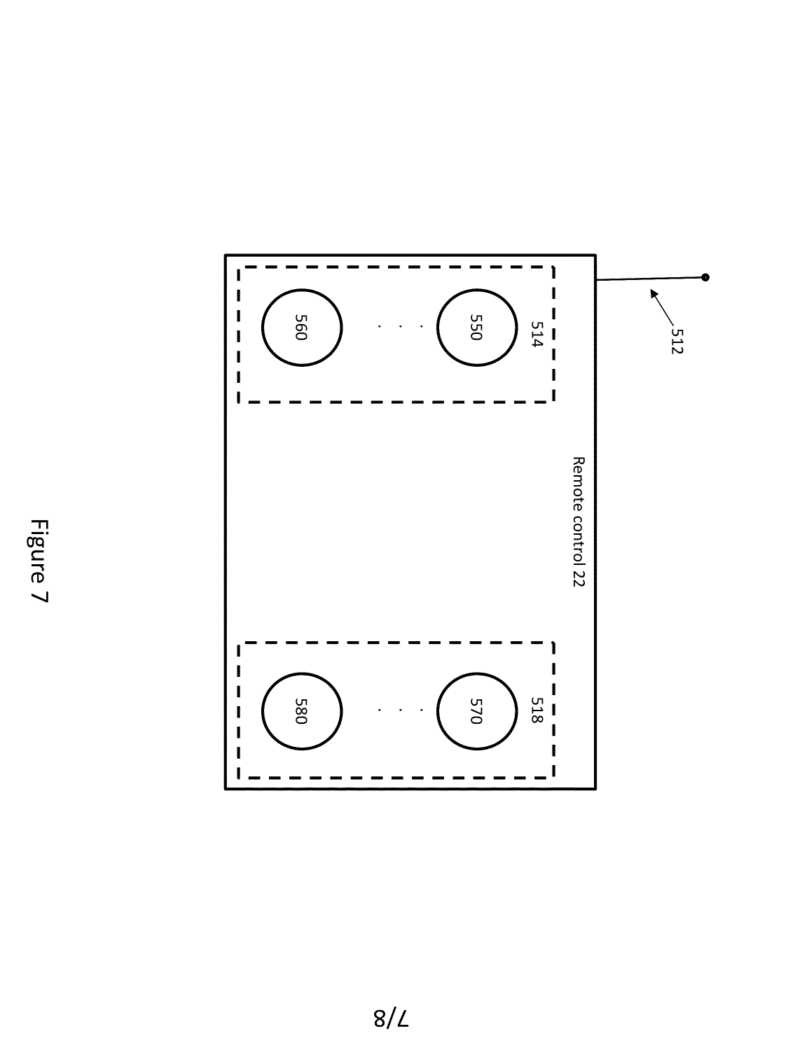

FIG. 7 is a detailed diagram of an external configuration of the remote control of the system of FIG. 1 according to an aspect of the invention. In particular, the display 514 may include in one particular aspect one or more lights 550-560. The lights 550-560 may be colored LEDs. The user interface 518 may include buttons 570-580. It one particular aspect, one particular button 570-580 may be used to activate a relevant one of the outputs 52 of the switch device 20. Activation of another one particular button 570-580 may be used to activate another switch device 20 output 52 that overrides the previous selection. The lights 550-560 may illuminate to indicate that a particular button 570-580 has been pressed. Another one of the lights 550-560 may illuminate to indicate that the switch device 20 failed to acknowledge, or failed to operate the switch 48 in conjunction with pressing one of the buttons 570-580. Yet another one of the lights 550-560 may indicate a low battery or the like.

In a further implementation, the remote control 22 may be implemented as a smart phone, tablet computer or the like. Such an implementation may utilize an application providing the functionality described above in conjunction with the remote control 22. Such an implementation may utilize the communication channels associated with the smart phone or tablet computer such as the short message service (SMS) messaging, or the like. Similarly, the switch device 20 may be implemented, at least in part, as a smart phone, tablet computer or the like. Such an implementation may utilize an application providing the functionality described above in conjunction with the switch device 20. Such an implementation may utilize the communication channels associated with the smart phone or tablet computer such as the short message service (SMS) messaging, or the like.

In yet a further implementation, the remote control 22 and the switch device 20 may include identification during a transmission and/or pairing prior to transmission. The identification and/or pairing allowing only a specific remote control 22 to operate with a specific switch device 20. This would prevent the remote control 22 of one user inadvertently operating the switch device 20 of another user resulting in possibly erroneous results.

In an embodiment, the remote control 22 and the switch device 20 each have a radio transceiver operating on a radiofrequency band which has a plurality of channels available. During a pairing operation, the two units select a single channel for their communications. Certain channels may provide better performance due to local radio noise. Therefore, the remote control 22 and/or the switch device 20 operate a software routine to optimize the channel selection. The remote control 22 and the switch device communicate with each other over each of the plurality of channels and build up a table of signal strengths to determine which channel is the best channel. The channel which is determined as the best channel is used for the communications.

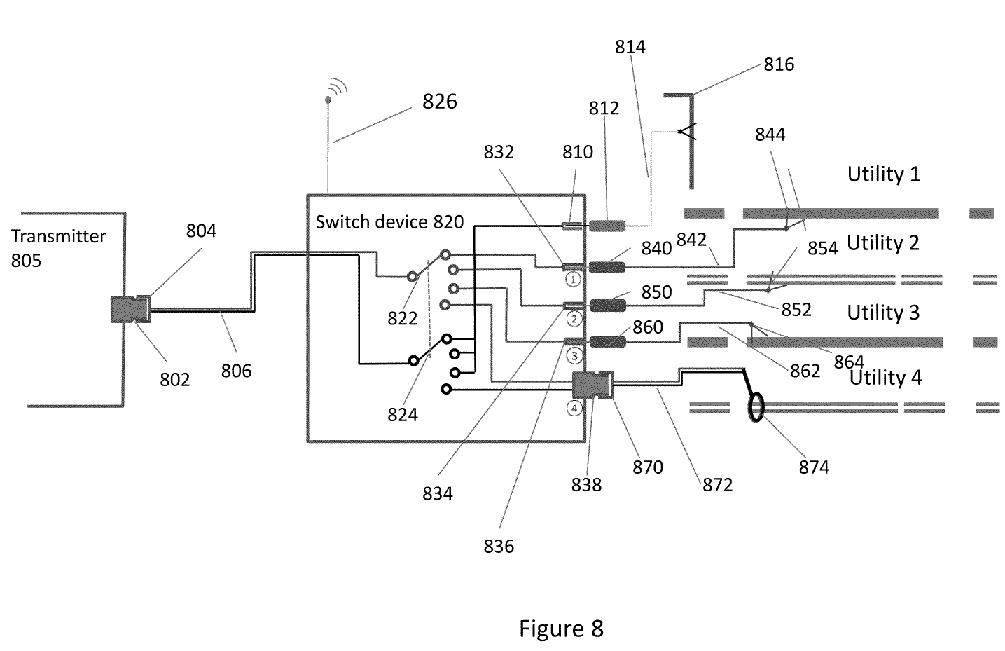

FIG. 8 shows a transmitter 805 and switch device 820 according to an embodiment. The switch device 820 is arranged to switch an alternating test current generated by the transmitter 805 between a first utility 102, a second utility 104, a third utility 106 and a fourth utility 108. The first to fourth utilities are buried conductors. The transmitter 805 has a connector 802 through which the alternating test signal is output. A plug 804 is coupled to the connector 804 and couples the alternating test signal to a lead 806 which runs from the transmitter 805 to the switch device 820. The lead 806 conductors: a first conductor which carries the alternating signal and a second conductor which acts as a ground return path.

The switch device 820 has ground socket 810. A plug 812 is coupled to the ground socket 810. A ground cable 814 connects the plug 812 to a ground stake 816. The ground stake 816 is inserted into the ground in which the first to fourth utilities are buried. The switch device 820 has a first direct connect socket 832, a second direct connect socket 834 and a third direct connect socket 836. Each of the direct connect sockets has a single connection for an alternating signal. The switch device also has a socket 838. The socket 838 has both a ground connection and an alternating signal connection.

A first plug 840 is coupled to the first socket 832 and connects the first socket to a first croc clip 844 with a first cable 842. The first croc clip 844 is attached to the first utility 102 and establishes a direct electrical connection with the first utility 102. A second plug 850 is coupled to the second socket 834 and connects the second socket 834 to a second croc clip 854 via a first cable 852. The second croc clip 854 is attached to the second utility 104 and establishes a direct electrical connection with the second utility 104. A third plug 860 is coupled to the third socket 836 and connects the third socket 836 to a third croc clip 864 with a third cable 862. The third croc clip 864 is attached to the third utility 106 and establishes a direct electrical connection with the third utility 106.

A fourth plug 870 is coupled to the fourth socket 838 and connects the fourth socket 838 to an inductive coupler 874 via a fourth cable 872. The inductive coupler 874 comprises a clamp which is connected around the fourth utility 108. The clamp allows the alternating test signal to be inductively coupled with the fourth utility 108. The clamp has two connections: a first, alternating signal connection through which the alternating test signal is applied and a second, ground connection through which the alternating test signal returns to the transmitter 805.

The switch device 820 comprises an antenna 826. The antenna 826 is configured to receive signals from a remote control as described above in relation to FIG. 5.

The switch device 820 comprises a first switch 822 and a second switch 824. The first switch 822 is configured to select the connection to the alternating signal output of the transmitter 805. The second switch 824 is configured to select the connection to the ground return path of the transmitter 805. The first switch 822 is linked to the second switch 824 so that the alternating signal connection selected by the first switch 822 corresponds to the ground connection selected by the second switch 824. When the first switch 822 selects one of the direct connection outputs for the alternating signal output, the second switch 824 selects the ground socket 810 as the ground return path. When the first switch 822 selects the fourth socket 838 which has a ground return path, the second switch 824 selects the fourth socket 838 as the ground return path.

In the embodiment described above, the direct connection plugs are implemented as banana plugs and the fourth plug 870 and socket 838 are implemented as a Neutricon plug and socket respectively. Those of skill in the art will appreciate that different numbers of direct connection and inductive connection sockets may be used. Further, additional types of connection may be made from the socket or sockets having both an alternating signal output and a ground return path. For example, a pair of DC leads may be connected to the fourth socket.

In an embodiment, the switches are implemented as relays

In an embodiment, the transmitter 805 has a test signal selector and is operable to select an alternating test signal according to the type of coupler attached to the connector 802 through which the alternating test signal is output. The couplers are identified by a link or a resistor, internally mounted, across two pins of the accessory plug. The transmitter 805 checks which coupler is plugged in and selects an appropriate set of output signals for the attached coupler. In such an embodiment, the switch device 820 is configured to allow the identity of the coupler connected to the fourth socket 838 to be fed back to the transmitter 805. This may be achieved by including additional signal lines to carry the coupler identity information.

In an embodiment, the switch device 805 is integrated with the transmitter 805. In such an embodiment, the socket 802, the plug 804 and the lead 806 which connect the transmitter to the switch device 802 are replaced by a direct internal connection.

Accordingly, as described above, the system for detecting a plurality of buried conductors overcomes a number of the disadvantages of conventional systems. The system allows the operator to be more efficient and requires less time for detecting a plurality of buried conductors.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

1. A system for detecting a plurality of buried conductors, the system comprising:
a transmitter configured to generate an alternating test signal for a plurality of buried conductors;
a receiver configured to detect an electromagnetic field produced by the alternating test signal in the plurality of buried conductors; and
a remote control configured to control the transmitter to generate the alternating test signal in one of the plurality of buried conductors.

2. A system according to claim 1, further comprising a plurality of couplers each configured to couple the alternating test signal with one of the plurality of buried conductors.

3. A system according to claim 2, wherein the transmitter is configured to connect to each of the plurality of couplers through a switch, wherein the switch is configured to connect the alternating test signal to one of the plurality of couplers.

4. A system according to claim 3, wherein the plurality of couplers comprise an inductive coupler configured to inductively couple the alternating test signal with a first buried conductor of the plurality of buried conductors and a direct coupler configured to directly couple the alternating test signal with a second buried conductor of the plurality of buried conductors.

5. A system according to claim 3, wherein the transmitter is configured to output the alternating test signal between an alternating output and a ground return path, the switch is coupled to a connection configured to be coupled to a ground stake inserted in the ground in which the plurality of buried conductors are buried and the switch is configured to couple the ground return path of the transmitter to the ground stake when the alternating test signal is connected to the direct coupler.

6. A system according to claim 3, wherein the transmitter comprises a test signal selector configured to select the alternating test signal according to a coupler type detected from a coupler connected to the transmitter, and wherein a first coupler of the plurality of couplers comprises a coupler type indicator indicating the coupler type of the first coupler, and the switch is configured to connect the coupler type indicator of the first coupler to the transmitter when the first coupler is connected to the transmitter.

7. A system according to claim 3, wherein the remote control is configured to operate the switch to select which one of the plurality of buried conductors receives the alternating test signal.

8. A system according to claim 7, wherein the remote control is configured to communicate with the switch over wireless connection comprising a plurality of channels and the remote control and the switch are configured to perform a pairing procedure to select one channel from the plurality of channels.

9. A system for detecting a plurality of buried conductors, the system comprising:
means for producing an alternating test signal in a plurality of buried conductors;
means for detecting an electromagnetic field produced by the alternating test signal in the plurality of buried conductors; and
means for remotely controlling the means for producing to generate the alternating test signal in one of the plurality of buried conductors.

10. A system according to claim 9, further comprising a plurality of couplers each configured to couple the alternating test signal with one of the plurality of buried conductors.

11. A system according to claim 10, wherein the means for producing an alternating test signal is configured to connect to each of the plurality of couplers through a switch, wherein the switch is configured to connect the alternating test signal to one of the plurality of couplers.

12. A system according to claim 11, wherein the plurality of couplers comprise an inductive coupler configured to inductively couple the alternating test signal with a first buried conductor of the plurality of buried conductors and a direct coupler configured to directly couple the alternating test signal with a second buried conductor of the plurality of buried conductors.

13. A system according to claim 11, wherein the means for producing an alternating test signal is configured to output the alternating test signal between an alternating output and a ground return path, the switch is coupled to a connection configured to be coupled to a ground stake inserted in the ground in which the plurality of buried conductors are buried and the switch is configured to couple the ground return path of the means for producing an alternating test signal to the ground stake when the alternating test signal is connected to the direct coupler.

14. A system according to claim 11, wherein the means for producing an alternating test signal comprises means for selecting the alternating test signal according to a coupler type detected from a coupler connected to the means for producing an alternating test signal, and wherein a first coupler of the plurality of couplers comprises a coupler type indicator indicating the coupler type of the first coupler, and the switch is configured to connect the coupler type indicator of the first coupler to the transmitter when the first coupler is connected to the means for producing an alternating test signal.

15. A system according to claim 11, wherein the means for remotely controlling is configured to operate the switch to select which one of the plurality of buried conductors receives the alternating test signal.

16. A system according to claim 15, wherein the means for remotely controlling is configured to communicate with the switch over wireless connection comprising a plurality of channels and the means for remotely controlling and the switch are configured to perform a pairing procedure to select one channel from the plurality of channels.

17. A method of detecting a plurality of buried conductors, the method comprising:
providing a transmitter for producing an alternating test signal in a plurality of buried conductors;
providing a receiver for detecting an electromagnetic field produced by the alternating test signal in the plurality of buried conductors; and
controlling the transmitter with a remote control to generate the alternating test signal in one of the plurality of buried conductors.

18. The method as claimed in claim 17, wherein the providing a transmitter includes connecting the transmitter to each of the plurality of buried conductors through a switch, wherein the switch is configured to transmit the alternating test signal to one of the plurality of buried conductors, the method further comprising associating the remote control with at least one of the transmitter and the switch to one of prevent and reduce erroneous operation, and wherein the remote control is configured to communicate with the switch over wireless connection comprising a plurality of channels and associating the remote control with at least one of the transmitter and the switch.

19. The method according to claim 17, further comprising providing a plurality of couplers each configured to couple the alternating test signal with one of the plurality of buried conductors.

20. The method according to claim 19, further comprising providing a switch, wherein the transmitter is configured to connect to each of the plurality of couplers through the switch, and wherein the switch is configured to connect the alternating test signal to one of the plurality of couplers.

21. The method according to claim 20, wherein the plurality of couplers comprise an inductive coupler configured to inductively couple the alternating test signal with a first buried conductor of the plurality of buried conductors and a direct coupler configured to directly couple the alternating test signal with a second buried conductor of the plurality of buried conductors.

22. The method according to claim 21, wherein the transmitter is configured to output the alternating test signal between an alternating output and a ground return path, the switch is coupled to a connection configured to be coupled to a ground stake inserted in the ground in which the plurality of buried conductors are buried and the switch is configured to couple the ground return path of the transmitter to the ground stake when the alternating test signal is connected to the direct coupler.

23. The method according to claim 19, wherein the transmitter comprises a test signal selector configured to select the alternating test signal according to a coupler type detected from a coupler connected to the transmitter, and wherein a first coupler of the plurality of couplers comprises a coupler type indicator indicating the coupler type of the first coupler, and the switch is configured to connect the coupler type indicator of the first coupler to the transmitter when the first coupler is connected to the transmitter.
